(19) United States
(12) Patent Application Publication
(10) Pub. No.: US 2007/0106457 A1
(43) Pub. Date: May 10, 2007

(54) PORTABLE COMPUTING WITH GEOSPATIAL HAPTIC COMPASS

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: OUTLAND RESEARCH, Pismo Beach, CA (US)

(21) Appl. No.: 11/535,417

(22) Filed: Sep. 26, 2006

Related U.S. Application Data
(60) Provisional application No. 60/736,089, filed on Nov. 9, 2005.

(51) Int. Cl. G01C 21/00; G01S 13/00; H04B 7/00; G01C 17/00; H04B 3/36

(52) U.S. Cl. 701/200; 340/407.1; 33/352; 342/147; 342/350

(57) ABSTRACT

A portable navigation device and associated methods are provided for enabling users to find geospatial orientations within the real physical world using their tactile senses. In one embodiment the portable navigation device acts as a geospatial compass, enabling users to find cardinal directions such as North in response to processor controlled tactile feedback sensations provided with respect to geospatial orientation sensor readings. In another embodiment the portable navigation device acts as a geospatial trajectory assisting device, enabling users to find travel direction indicated by a preplanned route or map in response to processor controlled tactile feedback sensations provided with respect to geospatial orientation sensor readings. In this way a user may perform a manual scanning operation wherein they manipulate the portable navigation device through a range of physical orientations and find a desired geospatial target orientation based upon their sense of touch.

### RELATED APPLICATION DATA

This application claims priority to provisional application Ser. No. 60/736,089, filed Nov. 9, 2005, the disclosure of which is hereby incorporated by reference as if fully set forth.

### FIELD OF THE APPLICATION

The present invention relates generally to operation a portable computing device having a geospatial haptic compass, and more particularly to a portable computing device for providing tactile feedback to a user corresponding to a direction of orientation of the portable computing device.

### BACKGROUND

With the recent reduction in cost and size of geospatial sensing transducers, many portable computing devices now provide users with real-time navigational information as they move about the physical word. A user, for example, can walk about the physical word with a cell phone that is equipped with geospatial sensing capabilities and be provided with real time maps, directions, compass information, accrued distance information, speed information, and other information indicative of their location, motion, and/or surroundings. Because users of portable computing devices need to look where they are going when walking about a physical area, it is often cumbersome to keep looking at a displayed compass, map, and/or other navigational display when navigating the physical word and desiring orientational information.

It is currently anticipated that users of portable computing devices in the future will desire orientational reference information to help them align themselves, their direction of travel, the direction they are looking, and/or the direction they are holding their portable computing devices with respect to the physical word. This is because portable computing devices in the future will be configured to receive and/or store information that is correlated specifically with particular geospatial locations and/or orientations within the physical word. For example, portable computing devices in the future will be configured to receive advertisements, reference information, virtual post-it notes, and other information that is stored and/or accessed based upon a user's then current position and orientation within the physical word. Thus to receive certain information within the physical word, users of portable computing devices will need to go to particular locations and orient themselves at or near specific orientation angles with respect to the physical world.

With respect to applications in which a user may desire to access information and/or store information that is correlated with particular locations in the physical world, a number of systems have been developed for accessing location related information, the location related information determined by one or more Global Positioning System (“GPS”) sensor local to a computing system. For example, U.S. Pat. No. 6,122,520, entitled “System and method for obtaining and using location specific information,” hereby incorporated by reference, describes a system that uses Navstar GPS, in combination with a distributed network, to access location related information based upon GPS coordinates. In addition U.S. Pat. No. 6,819,267, entitled “System and method for proximity bookmarks using GPS and pervasive computing,” hereby incorporated by reference, also describes a system for accessing location related information using GPS coordinates. U.S. Patent Application Publication No. 2005/0032528, entitled “Geographical web browser, methods, apparatus and systems,” hereby incorporated by reference, also describes a system for accessing location related information using GPS coordinates. In addition a number of co-pending U.S. Provisional Patent Applications by the present inventor address this field including No. 60/680,699 and 60/707,909 and 60/724,469 and 60/717,591 all of which are hereby incorporated by reference.

With respect to the technology for producing electronically controlled tactile sensations, such sensations are generally referred to as tactile sensations, haptic sensations, and/or force feedback sensations. Many hardware and software components for producing such sensations are known to the art. Many such components and related technologies are commercially available from Immersion Corporation, a provider of such technologies for use in commercial applications. For example, U.S. Pat. Nos. 5,739,811, 5,734,373, 5,959,613, and 6,211,861 describe haptic sensation technologies which are marketed by Immersion Corporation and may be used to provide tactile sensations in some embodiments of the current invention. These patents are hereby incorporated by reference. In addition, co-pending provisional U.S. Provisional Patent Applications by the present inventor address this field including 60/673,927 and 60/693,642 which are hereby incorporated by reference.

### SUMMARY

Embodiments of the present invention allow portable computing devices equipped with geospatial orientational sensing capabilities to provide users with orientational cues with respect to the earth in the form of tactile sensations. More specifically, embodiments of the present invention relate to cell phones, personal digital assistants, and other handheld computing devices that are equipped with geospatial sensing capabilities, the methods and apparatus according to the present invention enable such devices to provide their users with orientational cues in the form of tactile sensations felt by the user. Even more specifically, embodiments of the present invention enable a user of a portable computing device with geospatial sensing capabilities to feel tactile cues as he or she varies the orientation of the portable computing device with respect to the earth, the tactile sensations being provided when an orientational reference within the portable computing device passes through and/or is aligned with specific geospatial orientations such as magnetic NORTH, magnetic SOUTH, magnetic EAST, and magnetic WEST. As used herein, these primary geospatial directions (NORTH, SOTUH, EAST, and WEST) are referred to as Cardinal Directions. These orientations are generally conceptualized as falling within a local horizontal plane with respect to the surface of the earth.

The Cardinal Directions may be “magnetic” meaning they are referenced with respect to “magnetic NORTH” of the earth's magnetic field. The Cardinal Directions may alternately be “geographic” meaning they are referenced with respect to the geographic NORTH pole of the earth. Thus embodiments of the present invention may be configured to provide tactile sensations to feel tactile cues as he or she varies the orientation of the portable computing device with respect to the earth, the tactile sensations being provided when an orientational reference within the portable computing device passes through and/or is aligned with the direction of magnetic NORTH, SOUTH, EAST, or WEST. Similarly embodiments of the present invention may be configured to provide tactile sensations to feel tactile cues as he or she varies the orientation of the portable computing device with respect to the earth, the tactile sensations being provided when an orientational reference within the portable computing device passes through and/or is aligned with the direction of geographic NORTH, SOUTH, EAST, or WEST. In some embodiments the user may select which reference he or she desires sensations to be produces with respect to, magnetic Cardinal Directions or geographic Cardinal Directions. As discussed herein, the phrase “Cardinal Directions” refers to embodiments that support either or both references.

Embodiments of the present invention may also be configured to provide tactile sensations not only at the Cardinal Directions but also at other intermediate orientations. In many preferred embodiments the intermediate orientations are at regularly spaced intervals between the Cardinal Directions. For example, some embodiments may be configured to provide tactile sensations to the user each time an orientational reference within the portable computing device passes through and/or is aligned with one of a plurality of intermediate orientations, each of the intermediate orientations being positioned at 15 degree increments between each of the Cardinal Directions. As used herein, such incremental intermediate orientation positions between the Cardinal Directions are referred to as “Intermediate Incremental Directions.” These orientations are generally conceptualized as falling within a local horizontal plane with respect to the surface of the earth.

Embodiments of the present invention may also be configured to provide a plurality of different and distinct tactile sensations. In one such embodiment a first type of tactile sensation is provided when the orientational reference within the portable computing device passes through and/or is aligned with a Cardinal Direction and a second type of tactile sensation is provided when the orientational reference of the portable computing device passes through and/or is assigned with an Intermediate Incremental Direction. In some embodiments, the first and second types of tactile sensations may be different from each other by virtue of having a different magnitude, duration, frequency, and/or envelope. In an embodiment, the tactile sensation associated with the Cardinal Directions is of a perceptual form that is more pronounced and/or intense than the tactile sensations associated with the Intermediate Incremental Directions. For example, the tactile sensation associated with the Cardinal Directions is of a magnitude is larger than the tactile sensations associated with the Intermediate Incremental Directions. Similarly, the tactile sensation associated with the Cardinal Directions nay be configured with a duration is longer than the tactile sensations associated with the Intermediate Incremental Directions.

In addition, embodiments of the present invention may be configured such that voice synthesis hardware and software provides spoken reference information that corresponds with the displayed tactile cues. For example, a portable computing device may be configured to provide a tactile sensation when the user moves the portable computing device through the orientation corresponding with Cardinal NORTH. At the same time, or substantially so, embodiments of the present invention may also be configured to provide an audible sound that corresponds with an utterance of the word “NORTH.” In this way the user feels the sensation that precisely corresponds with the direction NORTH and hears the verbal utterance “NORTH” thereby informing him which direction the sensation corresponds to. Such a configuration enables a versatile orientation providing device for users that do not require users to look at a screen to perceive the orientational information.

With respect to the type of haptic sensations imparted by the portable computing device to inform the user about a spatial orientation, the sensations are such that a user can easily associate a particular orientation of the portable computing device with the presented tactile cue. Because a user will often be moving the portable computing device around in a scanning mode, the sensations are short in duration so they are crisply defined and thereby easy to associate with particular orientations of the portable computing device as it moves about in space. To enable a short duration tactile sensation to be crisp and distinct, a relatively high frequency sensation is generally effective. For example, a tactile sensation that is between 100 milliseconds and 500 milliseconds in duration and between 50 HZ and 200 HZ in frequency is often quite effective as an orientational cue. Such a quick, high frequency, haptic sensation is referred to herein as a “haptic tick-mark sensation” because it is short and crisp and can thereby be used to indicate a precise orientation as the user moves the portable computing device around in space.

The portable computing device according to the present invention is generally shaped such that it can be conveniently pointed along a particular orientation by the user. The portable computing device also includes a user interface component such as a button, knob, switch, lever, or trigger that the user manipulates to change modes and/or functions. In many embodiments of the present invention the user interface component is used by the user to enter a haptic scanning mode. When in the haptic scanning mode the portable computing device will provide tactile sensations with respect to certain geospatial reference orientations as the portable computing device is moved by the user to point in different directions within the horizontal plane. When not in the haptic scanning mode the portable computing device will not provide haptic sensations. Often the user will press and hold a button to enter the haptic scanning mode and then will move the portable computing device through a range of orientations around him. In this way, the user can selectively enable the tactile cues related to the geospatial orientations of the portable computing device. When tactile cues are enabled, the user will move the portable computing device through a range of orientations within the horizontal plane while feeling for resulting sensations and in this way will find one or more reference directions within the plane that have been associated with sensations. This action of moving the portable computing device through a range of orientations in the horizontal plane is referred to herein as scanning or sweeping the portable computing device.

The above summary of the present invention is not intended to represent each embodiment or every aspect of the present invention. The detailed description and Figures will describe many of the embodiments and aspects of the present invention.

### BRIEF DESCRIPTION OF THE DRAWINGS

The above and other aspects, features and advantages of the present embodiments will be more apparent from the following more particular description thereof, presented in conjunction with the following drawings wherein:

FIG. 1 illustrates a portable computing device according to at least one embodiment of the invention;

FIG. 2 shows a system enabled for geospatial information access and/or storage according to at least one embodiment of the invention;

FIG. 3 illustrates the computational architecture of a portable computing device according to at least one embodiment of the invention;

FIG. 4 illustrates a portable computing device with a user interface element adapted for use in enabling a haptic scanning mode according to at least one embodiment of the invention; and

FIG. 5 illustrates a flowchart of software operations related to the Haptic Compassing Routines according to at least one embodiment of the invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

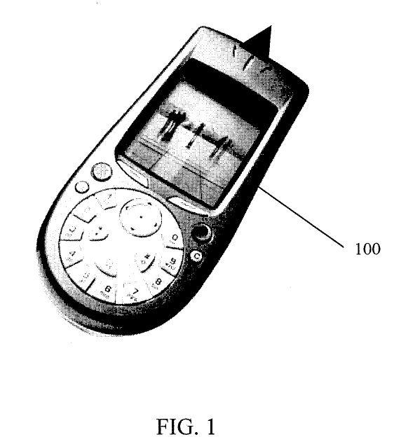

FIG. 1 illustrates a portable computing device 100 according to at least one embodiment of the invention. The portable computing device 100 is configured with appropriate hardware and software to support various embodiments discussed below. The portable computing device 100 may include a computer processor, an information display, a user interface, and a wireless communication link to an information network such as the Internet. The portable computing device 100 also includes an orientational sensor for determining a geospatial orientation of the portable computing device (or a portion thereof) in the physical world. The sensor is configured such that when the user aims the portable computing device (or a portion thereof) in a particular direction, the sensor can determine an orientation of the portable computing device with respect to a known reference. In many embodiments the known reference is magnetic NORTH and/or geographic NORTH. Because the user will aim the portable computing device, or a portion thereof, in a particular direction, the portable computing device (or aimable portion) generally includes a physical reference upon the casing or other aimable component to indicate a front portion that is to be aimed and/or aligned with particular orientations. As shown in FIG. 1, the portable computing device 100 includes a molded arrow indicia intended to inform the user which portion of the portable computing device is being tracked by the orientational sensor.

With respect to the orientational sensor mentioned above, a variety of electronic sensing modules exist. A common sensor for sensing geospatial orientation is a magnetometer that detects orientation with respect to the earth's magnetic field. The earth's magnetic field is about 0.6 gauss in an open-air environment, and has a direction from the earth's magnetic SOUTH pole to the earth's magnetic NORTH pole. This pointing to the NORTH pole is the basis for magnetic compassing using electronic sensor components. At the equator, the magnetic field direction is a horizontal vector, but as one moves further into the northern or southern hemispheres the magnetic field will point partially downwards (northern hemisphere) or upwards (southern hemisphere). This angle down or up at the earth's surface is called the inclination angle or dip angle.

Two-axis magnetic compass electronic modules, which may be used as the orientation sensor within embodiments according to the present invention, measure the horizontal vector components of the earth's magnetic field using two sensor elements in the horizontal plane but orthogonal to each other. Called the X and Y-axis sensors, each sensor on an electronic compass assembly measures the magnetic field in its sensitive axis and the arc tangent Y/X provides the heading of the geospatial compass with respect to the X-axis. A two-axis compass can remain accurate as long as the sensors remain horizontal with respect to the surface of the earth, or orthogonal to the gravitational (downward) vector. Three-axis magnetic compasses, which may also be used as the orientation sensor within embodiments of the present invention, contain magnetic sensors in all three orthogonal vectors of an electronic compass assembly to capture the horizontal and vertical components of the earth's magnetic field.

Because it is often difficult for a user of a portable computing device 100 equipped with compass orientation sensors to hold the device such that the sensor is perfectly horizontal, additional sensors can be used in the present invention to compensate for tilt across a range of angles. To electronically compensate for tilt, the magnetic sensors are complemented by a tilt-sensing element to measure the gravitational direction. The tilt sensor provides two-axis measurement of compass assembly tilt, known as pitch and roll axis. The five axes' of sensor inputs are combined to create a “tilt-compensated” version of the X- and Y-axis magnetic vectors, and then computed into a tilt-compensated heading. Such a tilt compensated magnetic sensor may be used to provide robust orientational sensor readings that operate across a range of tilt angles for the portable computing device 100 (or aimable portion thereof).

The discrete sensing elements employed in such sensor modules are generally called magnetometers and/or mango-inductive sensors. These sensing elements when combined with signal conditional electronics and/or tilt compensation components are generally called electronic compassing sensor modules and/or digital compassing sensor modules. Regardless of their specific configuration, electronic compassing sensor modules are components that can be integrated into the portable computing device 100 and can provide geospatial orientational data with respect to the physical world. Examples of specific sensor modules that may be used within embodiments of the present invention include the Vector-2X from PMI which is a multi-axis digital orientation sensing module that provides geospatial orientation data with 1.0 degree resolution and 2.0 degree accuracy. The V2XE from PMI may also be used. It is a similar module that provides 0.01 degree orientational resolution and 2 degree accuracy. It uses mango-inductive sensors that change their inductance based upon their orientation within the earth's magnetic field. Honeywell offers a complete line of electronic compass modules from the basic HMR3100 two-axis electronic compass to the HMR-3300 with ±60 degrees of tilt compensation that may be used within the present invention. For example, the HMR3000 Digital Compass Module is a three-axis compass featuring 0.5 degree accuracy and a fluidic tilt sensor for ±45 degree compensation. The HMR3100 Digital Compass Solution is a low cost, 19 mm by 19 mm daughter-board module for basic heading measurements and optimized for 3.0 volt operation. The HMR3200 Digital Compass Solution is a module featuring two-axis compassing in horizontal or vertical PCB orientations with 1 degree of accuracy and 0.1 degree of resolution. The HMR3300 Digital Compass Solution is a module featuring three-axis compassing with an onboard MEMs accelerometer for ±60 degree tilt sensing and up to 1 degree accuracy and 0.1 degree resolution.

Referring back to FIG. 1, the portable computing device 100 may also include a GPS transceiver for sensing the geographic location of the portable computing device with a high degree of accuracy. The GPS transceiver may also be used to detect orientational information depending upon configuration and/or usage. Also the portable computing device 100 is shaped such that it can be conveniently pointed at a remote location by a user. The portable computing device 100 also includes a user interface component such as a button, knob, switch, lever, or trigger that the user manipulates to change modes and/or functions. In many embodiments, the user interface component is used by the user to enter a haptic scanning mode. When in the haptic scanning mode the portable computing device 100 will provide tactile sensations with respect to certain geospatial orientational values. When not in the haptic scanning mode the portable computing device will not. Often the user will press and hold a button to enter the haptic scanning mode. In this way, the user can selectively access and/or not access the tactile cues related to the geospatial orientations of the portable computing device 100 (or portion thereof) in the physical world.

When tactile cues are enabled, the user will generally move the portable computing device 100 through a range of orientations while feeling for resulting sensations and in this way will find one or more reference directions that have been associated with sensations. For example, if the user wants to find the direction NORTH, the user will enter a haptic scanning mode by, for example, pressing and holding a button on the side of the portable computing device. The user may also indicate to the user interface by pressing a button, selecting a touch screen element, issuing a voice command, or otherwise expressing a preference that he or she desires to find the direction NORTH. Based upon this input, the portable computing device software will be configured to provide a sensation if and when the portable computing device (or a specified portion thereof) is aimed at the NORTH cardinal direction. The user will then move the portable computing device 100 through a range of orientations, usually while holding the portable computing device 100 substantially level, until the user feels a haptic sensations. This action of moving the portable computing device 100 through a range of orientations is referred to herein as sweeping the portable computing device 100. Thus the user will sweep the portable computing device 100 until he or she feels a sensation. The user may feel the sensation while the portable computing device 100 is in motion at the moment (or substantially so) that the portable computing device 100 passes through the NORTH direction. This sensation may be, for example, a sinusoidal vibration sensation of frequency 78 HZ, duration 200 ms, and magnitude of 40%. Upon feeling this tactile cue, the user will generally slow down, reverse direction, and re-aim at portable computing device 100 back in direction. Upon passing through again, the user will feel the tactile sensation again. In this way the user will home-in on the NORTH direction. Upon achieving alignment with NORTH (as apposed to momentary pass-through), the user may be provided with a different haptic sensation to indicate that the portable computing device is being held within a certain threshold angle of the reference angle NORTH. This alignment sensation will generally be longer in duration and/or higher in magnitude than the pass-through sensation. This sensation may be, for example, a sinusoidal vibration sensation of frequency 90 HZ, duration 500 ms, and magnitude of 60%. In some embodiments the duration may be substantially longer for the alignment sensation and may gradually fade away over time.

Thus by performing the haptic scanning operation described above, the user, by sweeping the portable computing device through a range of orientations, while feeling the resulting sensations, is enabled by embodiments of the present invention to find one or more reference directions within the real physical world through the sense of touch. Although the above example demonstrates how the user can use embodiments of the present invention to find the direction NORTH without needing to look at a screen (as would be required of a traditional compass), any other compass directions can be found in the same way (for example 22.5 degrees away from NORTH).

One advantage of embodiments of the present invention is that the touch method enables the user to find a direction quickly, in fact quicker than is often required of a visual compassing method, because the user need not look at a screen. This is because the tactile sense is a high bandwidth sensory modality for human organisms through which they can process information quickly, very rapidly allowing users to associate a tactile cue with a particular kinesthetic orientation of their body.

Referring back to FIG. 1, within or upon the portable computing device are haptic actuators (not shown) and control components (not shown) and software routines (not shown) that enable tactile sensations to be imparted upon the user under electronic control. These haptic components enable the selective presentation of tactile sensations to the user to inform the user as to the presence and/or type of spatial orientation reference within the real physical space. Furthermore, some embodiments of the present invention are configured in hardware and/or software to select and provide a specific tactile sensation cue (also referred to herein as a tactile cue or haptic cue) from among a plurality of different and perceptually distinguishable tactile sensation cues. In some embodiments of the present invention, the particular tactile cue is selected and imparted to alert the user that their portable computing device (or a portion thereof) has crossed an orientational reference and/or is aligned with an orientational reference of a particular type. One type of orientational reference is a Cardinal Direction. Another type of orientational reference is an Intermediate Incremental Direction. In some embodiments certain Intermediate Incremental Directions, such as 45 degrees between two Cardinal Directions, are associated with different tactile sensation cues than other Intermediate Incremental Directions, such as every 15 degrees between Cardinal Directions.

Thus the portable computing device 100 is equipped with one more haptic actuators and haptic control electronics/software for selectively generating one or more tactile sensations upon the user to inform the user when the portable computing device (or a portion thereof) passes through and/or is aligned with a particular geospatial orientation. An example of haptic actuators and haptic control electronics for delivering haptic sensations to a user is disclosed in issued U.S. Pat. No. 6,211,861, which was co-invented by Rosenberg (the same inventor as the present application) and is hereby incorporated by reference. Other types of haptic actuators may be used as well. Some actuators may be mounted upon a user contactable surface of the portable computing device. Other actuators may be mounted within the casing of the portable computing device. In many embodiments the actuators impart vibro-tactile sensations upon the user by inducing vibration forces within the casing held by the user. U.S. Pat. Nos. 5,739,811 and 5,734,373 and 5,959,613 also describe haptic hardware and/or software and/or control technologies which may be employed in embodiments of the current invention and are hereby incorporated by reference.

Referring next to the above-mentioned patents, disclosed are some example actuators that may be incorporated into the casing of the portable computing device of embodiments of the present invention to generate and impart the required tactile sensations. These particular actuators generate and impart haptic sensations by moving an inertial mass under electronic control, the inertial mass being moved by the actuator to create rapidly changing forces that can be felt by the user as a distinct and informative tactile cue. Routines running upon the processor of the portable computing device select and impart sensations by sending appropriate signals, through power amplifier electronics, to one or more actuators within the portable computing device. The routines running upon the processor of the portable computing device 100 are operative to read one or more geospatial orientational sensors and in response to data received form the sensors, selectively impart an appropriate tactile cue upon the user at an appropriate time. For example, the routines running upon the processor of the portable computing device repeatedly reads one or more geospatial orientational sensors, such as a digital compass module, and determines based upon the repeated data accessed that the portable computing device (or a portion thereof) has just crossed and/or has just aligned with an orientation corresponding with geographic NORTH. Upon determining that NORTH has just been crossed and/or aligned with, the routines running upon the processor of the portable computing device select a particular tactile cue definition from a plurality of such definitions from memory and impart that sensation upon the user. The sensation is imparted within very close time-proximity of the detected orientation crossing and/or alignment such that to the user it is perceived as being substantially simultaneous. Thus the user receives the tactile cue that informs him or her that the portable computing device (or a selected portion thereof) is aimed at geographic NORTH. This provides increased situational awareness for the user with respect to the physical world with respect to his or her orientation in the world. As used herein, the software routines that read orientational data from one or more geospatial sensors on board the portable computing device 100 and in response to changes in the data command a tactile sensation upon the user that corresponds with one or more geospatial orientations, are called Haptic Compassing Routines. This software is described in more detail below.

With respect to the actuators, one or more haptic actuators are incorporated upon or within the portable computing device 100 such that when selectively activated by the Haptic Compassing Routines, the user feels a tactile sensation. There are many such actuators known the art and many methods by which haptic actuators may be controlled to impart haptic sensations known to the art. One such actuator may be incorporated into the portable computing device 100 (or a peripheral thereof) such that when energized the user will feel a haptic sensation as a result of changing forces imparted by the actuator. In this embodiment, the actuator imparts forces as inertially induced vibrations that are transmitted to the user through the casing of the portable computing device 100. The actuator has a spinning shaft which can be rotated continuously in one direction or oscillated back and forth by a fraction of a single revolution. An arm is coupled to the shaft approximately perpendicularly to the axis of rotation of the shaft. An inertial mass is coupled to the other end of the arm. When the shaft is rotated continuously or oscillated, forces are imparted to the housing of the portable computing device from the inertia of the moving inertial mass. The user who is holding the housing of the portable computing device will feel the forces as haptic sensations.

Another type of actuator utilizes a motor or other electronically controllable actuator having a rotating shaft. An actuator plug has a high-pitch internal thread which mates with a pin extending from the side of the rotating shaft of the motor, thus providing a low cost lead screw. When the shaft is rotating, the pin causes the plug to move up or down along the axis; when the shaft is oscillated, the plug acts as an inertial mass (or can be coupled to the inertial mass) and an appropriate tactile sensation is provided to the casing of the portable computing device.

In other embodiments, different types of actuators can be used. For example, a solenoid having a vertically-moving portion can be used for the linear actuator. A linear voice magnet, DC current controlled linear motor, a linear stepper motor controlled with pulse width modulation of an applied voltage, a pneumatic/hydraulic actuator, a torquer (motor with limited angular range), a piezo-electric actuator, etc., can be used. In some embodiments a surface of the portable computing device itself may be comprised of a electronically responsive material such as electro-active polymer and/or piezoceramic that can be controlled to produce tactile sensations felt by a user holding the device.

Another suitable actuator is a low cost, low power component and has a high bandwidth and a small range of motion. This actuator is a voice coil actuator that includes a magnet portion and a bobbin. The magnet portion is grounded and the bobbin is moved relative to the magnet portion. In other embodiments, the bobbin can be grounded and the magnet portion can be moved. The magnet portion includes a housing made of a metal such as steel. A magnet is provided within the housing and a pole piece is positioned on magnet. The magnet provides a magnetic field that uses steel housing as a flux return path. The pole piece focuses the flux into the gap between pole piece and housing. The housing, magnet portion, and bobbin may be cylindrically shaped, but can also be provided as other shapes in other embodiments.

The bobbin is operative to move linearly with respect to magnet portion. The bobbin includes a support member and a coil attached to the support member. The coil may be wound about the support member in successive loops. When the bobbin is moved, the coil is moved through the magnetic field. An electric current is flowed through the coil via electrical connections. As is well known to those skilled in the art, the electric current in the coil generates a magnetic field. The magnetic field from the coil then interacts with the magnetic field generated by the magnet to produce a force. The magnitude or strength of the force is dependent on the magnitude of the current that is applied to the coil and the strength of the magnetic field. Likewise, the direction of the force depends on the direction of the current in the coil. The inertial mass may be coupled to the bobbin and move linearly with the bobbin. The operation and implementation of force using magnetic fields is well known to those skilled in the art.

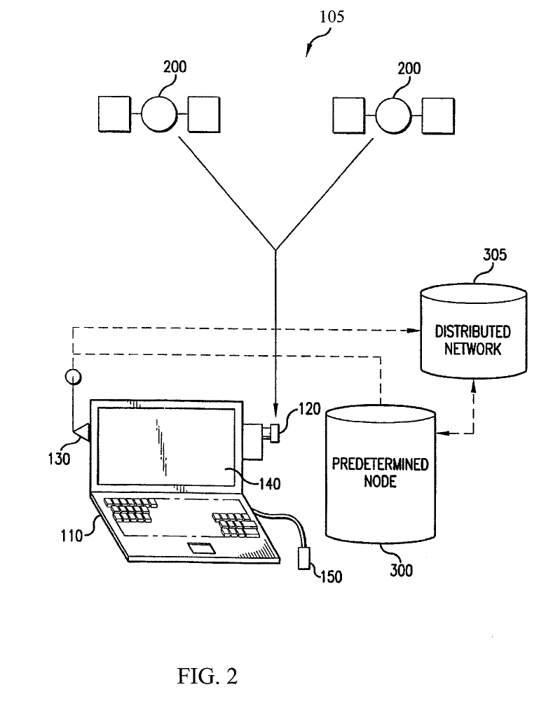

FIG. 2 shows a system 105 enabled for geospatial information access and/or storage according to at least one embodiment of the invention. As seen in the figure, the system 105 includes a portable computing device 110 such as a personal digital assistant (PDA) or cell phone or portable gaming system or portable media player configured with the appropriate hardware and software to support the current invention. As shown in the figure, the system includes a GPS receiver 120 and a radio transmitter/receiver, e.g., transceiver 130, and one or more orientation sensors such as a magnetometer (not shown) and an accelerometer (not shown). The GPS receiver 120 receives signals from three or more GPS transmitters 200 and converts the signals to a specific latitude and longitude (and in some cases altitude) coordinate as described above. The GPS receiver 120 provides the coordinate to the software running upon portable computing device 110. The orientation sensors provide orientation data to software running upon the portable computing device 110, the orientation data indicating the direction at which the portable computing device is pointing when aimed at a remote location by the user.

Such a system is shown because a common usage of embodiments of the present invention is to help a user orient himself with respect to spatially associated information (i.e., information that is associated with particular GPS coordinates). For example, a particular piece of spatially associated information may inform the user that he or she should look in a particular direction, for example due WEST or 40 degrees EAST of NORTH, to see a particular sight, such as a mountain peak or restaurant or a gas station. To find the associated orientation, the user may access the target orientation over a network when accessing a piece of spatially associated information. The target orientation may be a discrete orientation vector with respect to the physical world or may be a range or orientations. The user may then perform a haptic scanning operation in which he or she moves the portable computing device around by sweeping through a range of orientations. When the target orientation is crossed and/or aligned with the target orientation, a tactile cue is generated and imparted upon the user. This cue thereby informs the user as to the direction of the target orientation with respect to his physical location in the world. For example, if the target orientation corresponded with the direction which a user should look to see a particular mountain peek, as the user sweeps his or her portable computing device around the tactile sensation is imparted corresponding with the moment in time when the device (or an aimable portion thereof) is aligned at the direction the user should look. In this way the user is informed as to which direction he or she should look.

Such spatially associated information embodiments are enabled whereby portable computing device transmits, via the transceiver 130, the devices current GPS coordinates to a node 300 of the distributed network 305. The distributed node is operative to provide information back to the portable computing device associated with those coordinate (or associated with a location that falls within the range defined by those coordinates) residing thereon. In this way, some embodiments of the present invention may receive from the distributed network, one or more target orientations, the target orientation(s) being used to trigger tactile sensations by the Haptic Compassing Routines.

The GPS receiver 120 of the targeting-location-information-system 100 is can be, for example, a PCMCIA Pathfinder Card (with associated hardware and/or software) manufactured by Trimble Navigation Ltd., Sunnyvale, Calif., for receiving information from the GPS transmitters 200. The GPS receiver 120 may be integrated directly into the portable computing device and not be an extractable card. The radio transceiver 130 of the targeting-location-information-system 100 can be a cellular modem radio or other wireless link. The radio transceiver 130, for example, may work with a Ricochet Wireless Network system manufactured by Metricom, Inc. The radio transceiver 130 may also comprise other systems, such as, for example, a cellular digital packet data (CDPD) type radio transceiver. The radio transceiver 130 may also, for example, be a Bluetooth wireless communication connection.

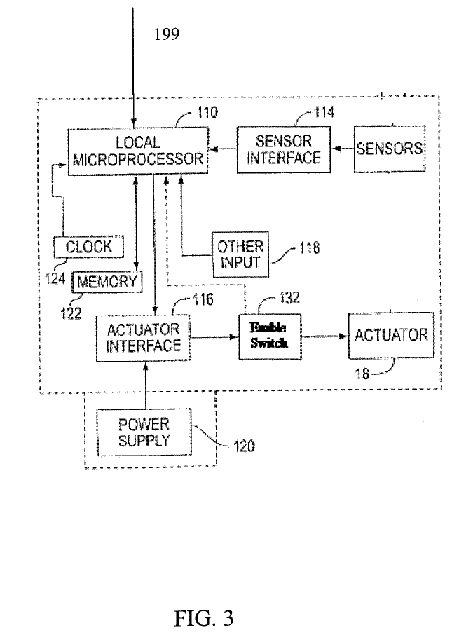

FIG. 3 illustrates the computational architecture of a portable computing device 100 according to at least one embodiment of the invention. As shown in the figure, the portable computing device 100 includes a processor 110 for running the Haptic Compassing Routines. The processor may comprise one microprocessor chip, multiple processors and/or co-processor chips, and/or digital signal processor (DSP) capability. As shown in FIG. 3, processor 110 is configured to receive signals from sensor 112 and provide signals to actuator 18 in accordance with the Haptic Compassing Routines. Sensor 112 includes one or more geospatial sensors that provide orientational data with respect to the physical world. Sensor 112 may be, for example, one or more magnetometers. In a preferred embodiment sensor 112 is an integrated digital compass module with tilt compensation as described previously.

In addition, processor 110 may send and receive information from an external communication signal 199. This information may include spatially associated information received from a distributed network.

In addition, processor 110 receives data from one or more user interface components upon the portable computing device. The data may describe, for example, the states of buttons, levers, and other input devices 118 and/or an enable switch 132. The processor may use this data to update executed programs, including the Haptic Compassing Routines.

Under the control of the Haptic Compassing Routines, processor 110 is operative to read orientational data from sensors 112 and optionally additional user interface data from user interface components such as 118 and 132. In some embodiments the haptic compassing routines are dependent upon a user interface input such as a button press that engages the device in a haptic scanning mode. When the particular button press is detected, the haptic scanning mode is such that sensations are provided to the user when the portable computing device crosses (i.e., passes through) certain geospatial orientations and/or aligns with certain geospatial orientations. In response to such detected pass-throughs and/or alignments, the routines of embodiments of the present invention selectively control actuator 18 with actuator control signals. Thus under the control of the Haptic Compassing Routines, processor 110 is operative to selectively control one or more actuators 18 by sending a haptic control signal to actuator electronics 116. Actuator electronics may include power amplifier circuits and/or other circuits for converting the haptic control signal from processor 110 to a drive signal that will drive actuator(s) 18. Based upon the timing and form of haptic control signals supplied by processor 110 under the control of Haptic Compassing Routines, tactile sensations are selectively produced. Under normal operation, the Haptic Compassing Routines selectively produce tactile sensations in response to orientation data read from sensors 112 and optionally based upon the state of one or more user interface components such as 118 and/or 132.

When in haptic scanning mode the angles used for as the determined orientation of the portable computing device based upon sensor readings are the projections into the horizontal plane. Thus even if the portable computing device is tilted some amount upwards or downwards (away from the ground) when pointing NORTH, the orientation determined is generally still NORTH. This is what is meant by the projection into the horizontal plane. To avoid inaccuracies caused by tilt, tilt-compensating sensors are often used in generating the digital compassing data. Thus when referring to orientation angles herein, they generally refer to projections into the horizontal plane. This can be thought of as the yaw angle for the portable computing device while pitch and roll angles are generally ignored or compensated for. In some embodiments the user must hold the portable computing device (or the aimable portion thereof) in an orientation such that it is substantially oriented in the horizontal plane (i.e., pitch and roll angles are small).

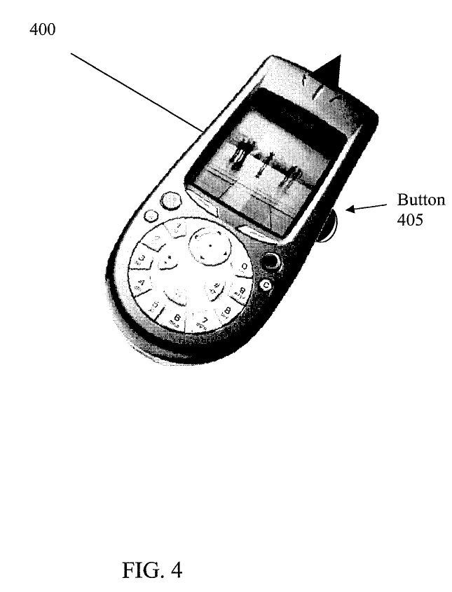

FIG. 4 illustrates a portable computing device 400 with a user interface element adapted for use in enabling a haptic scanning mode according to at least one embodiment of the invention. The user presses and holds the button 405 shown in FIG. 4 to enter a haptic scanning mode. When the user releases the button 405, the haptic scanning mode is disabled. In this way the user can press and hold the button 405, sweep the portable computing device 400 through a range of orientations, and based upon the electronically generated tactile sensations, can find one or more geospatial reference orientations with respect to the real physical world. Although a button 400 is shown as the specially adapted user interface element for enabling haptic scanning in FIG. 4, other user interface elements may be used for such a purpose in various embodiments of the present invention. In some embodiments, a multi-position rocker switch is used that may be depressed in four positions, each position corresponding with one of NORTH, SOUTH, EAST, and WEST. When pressed into a particular position, haptic scanning is enabled specifically for the reference orientation associated with that position. Thus if the user presses and holds the multi-position rocker switch in the SOUTH position, the user will feel tactile sensations associated with the geospatial orientation SOUTH when sweeping the portable computing device. Alternately if the user presses and holds the multi-position rocker switch in the EAST position, the user will feel tactile sensations associated with the geospatial orientation EAST when sweeping the portable computing device. In some embodiments, such a multi-position rocker switch may have more positions for intermediate orientations such as NORTH-WEST, SOUTH-WEST, SOUTH-EAST, and NORTH-EAST.

In some embodiments the reference orientation is computed by the software in real-time based upon the current location of the user and the location of a specified target. For example, a user may be traveling towards a target (a mountain) that is at a location T. At any given time a GPS sensor on board the portable computing device may determine that the user is currently located at a location P. Thus the user may which to know the orientation direction that points from P to T at various points in time. The device may be configured in such a target tracking mode, such that a tactile sensation will be provided whenever the portable computing device is aimed in the direction of the target. To enable this mode, the software of embodiments of the present invention is configured to compute a current reference orientation based upon location T of the target and a currently updated location P of the portable computing device. By performing a vector subtraction of T minus P, the orientation pointing from P to T may be determined. This orientation is then used as the geospatial reference orientation by the Haptic Compassing Routines. In this way the user is provided with a tactile sensation while enabling a haptic scanning mode when the portable computing device passes-through an orientation pointing towards target T and/or remains aligned with an orientation pointing towards target T. The tactile sensation may be, for example, a sinusoidal vibration sensation of frequency 60 HZ, duration 300 ms, and magnitude of 50% when passing through a geospatial orientation aimed at target location T. The tactile sensation may also be, for example, a sinusoidal vibration sensation of frequency 80 HZ, duration 1200 ms, and magnitude of 70% when remaining aligned with the direction of target location T for more than a certain threshold of time.

Herein, the term “tactile sensation” refers to either a single force or a sequence of forces output by the actuator 18 which provide a haptic sensation to the user. For example, vibrations, a single jolt, or a texture sensation are all considered tactile sensations. The microprocessor 110 can process inputted sensor signals to determine appropriate output actuator signals by following stored instructions. In generally, one or more algorithms are used to produce haptic sensations based upon the current readings of sensor signals. For example, a particular haptic sensation may only be output if and when the sensor signals report that the portable computing device (or a portion thereof) is aimed such that it passes through a Cardinal Direction and/or is held aligned with a Cardinal Direction. In some embodiments a different tactile sensation is selected and imparted by the Haptic Control Routines for a pass-through of a Cardinal Direction as opposed to an extended alignment with a Cardinal Direction (within certain angular threshold limits). In this way the user may distinguish tactually if they have moved the personal computing device such that it has momentarily passed across or through a Cardinal Direction as compared to if they are steadily holding the device such that it is substantially aligned (within certain angular threshold limits) with a Cardinal Direction. In some embodiments the sensation associated with a pass-through is of shorted duration and/or lower magnitude than the sensation associated with an extended alignment. The same differences can be used for pass-through and extended alignment with Intermediate Incremental Directions.

Referring to FIG. 3, local memory 122, such as RAM and/or ROM, may be coupled to microprocessor 110 to store instructions for microprocessor 110 and store temporary and other data. For example, force profiles can be stored in memory 122, such as a sequence of stored force values that can be output by the microprocessor to the actuator, or a look-up table of force values to be output to the actuator based on whether or not the portable computing device passes through and/or is aligned with a Cardinal Direction and/or with an Intermediate Incremental Direction and/or with a Target Direction. In addition, a local clock 124 can be coupled to the microprocessor 110 to provide timing data; the timing data might be required, for example, to compute forces output by actuator 18.

Also, the local memory can store predetermined force sensations to be sent by the microprocessor to the actuator (or actuators) aboard the portable computing device that are to be associated with particular types geospatial directions and/or alignments. For example, different sensations can be stored that are associated with Cardinal Directions, Intermediate Incremental Directions. Similarly different sensations can be stored that are associated with pass-through of particular geospatial orientations, extended alignments of particular geospatial orientations, and/or other similar variants.

Also, the local memory can store a plurality of data files including sound files, image files, and/or other media files. One of the plurality of data files can be selected from memory in combination and/or coordination with displayed tactile sensations. For example a digitized human voice uttering the words “NORTH”, “SOUTH”, “EAST”, and “WEST” can be stored in memory on board the portable computing device and accessed when the respective Cardinal Direction is passed-through and/or aligned with by the portable computing device. Such audio files can be played in combination with the tactile sensations such that the user can feel a cue at the precise moment the orientation is passed through and/or aligned with and then receive audio information as to which Cardinal Direction the tactile cue is associated with. This is a particular useful feature because the audio information by itself is not highly informative during a scanning move by the user because the audio signal may take many seconds to play and thus is not clearly coordinated with a particular moment in time (and thus a particular orientation of the portable computing device as wielded by the user during a scanning operation). The haptic cue on the other hand may be very abrupt, lasting only hundred(s) of milliseconds and thus may be precisely coordinated in time and place during a scanning operation.

Actuator 18 transmits forces to the housing of the portable computing device in response to signals received from microprocessor 110. In some embodiments, actuator 18 is provided to generate inertial forces by moving an inertial mass. The actuator described herein has the ability to apply short duration force sensations on the casing of the portable computing device. In progressively more advanced embodiments, a “periodic force sensation” can be applied to the user through the unit, where the periodic sensation can have a magnitude and a frequency, e.g., a sine wave. The periodic sensation can be selectable among a sine wave, square wave, saw-toothed-up wave, saw-toothed-down, and triangle wave. An envelope can be applied to the period signal, allowing for variation in magnitude over time. The resulting force signal can be “impulse wave shaped” as described in U.S. Pat. No. 5,959,613, the disclosure of which is hereby incorporated by reference.

Actuator interface 116 can be optionally connected between actuator 18 and microprocessor 110 to convert signals from microprocessor 110 into signals appropriate to drive actuator 18. Interface 38 can include power amplifiers, switches, digital to analog controllers (DACs), analog to digital controllers (ADCs), and other components, as is well known to those skilled in the art.

Other input devices 118 may be included within the portable computing device and send input signals to microprocessor 110 or to computer 14 when manipulated by the user. Such input devices include buttons 16 and can include additional buttons, dials, switches, scroll wheels, or other controls or mechanisms. In addition the other input devices may include a tilt-sensor such as a multi-axis accelerometer for determining the orientation of the portable computing device with respect to the direction of gravity. Other input devices may include a microphone and software routines for capturing and processing voice commands.

A user may engage a haptic scanning mode by pressing and holding a button or other control on the portable computing device. An alternate inventive method is to use a tilt-sensor to enable a user to more naturally enter the haptic scanning mode. Under a tilt-activated embodiment, the user may enter a haptic scanning mode by holding the portable computing device in a substantially horizontal orientation with respect to the physical world. By horizontal it means that the portable computing device (or a designated portion thereof) lies substantially in the plane that is parallel with the surface of the earth. Said another way, it means that the computing device (or a designated portion thereof) lies substantially perpendicular to the direction of gravity. By “substantially” in this context is means that it is being held within a certain number of degrees in each direction, for example plus or minus 10 degrees. Thus in a tilt-activated mode, software routines of embodiments of the present invention monitor the tilt angle of the portable computing device by reading tilt sensor values at regular rapid intervals and determine based upon sensor readings that the device is substantially horizontal (or a designated portion thereof) for more than some threshold amount of time and in response activate the haptic scanning mode. The software then continues to monitor the tilt sensors and upon determining that the device is no longer being held at a substantially horizontal orientation, terminates the haptic scanning mode. In this way, the user may simple take the portable computing device out of his or her pocket (or other holder) and by simply holding it out before him in a generally horizontal orientation, may naturally and quickly engage the haptic scanning mode.

Power supply 120, ideally including batteries, is included in the portable computing device and is coupled to actuator interface 116 and/or actuator 18 to provide electrical power to the actuator. Enable switch 132 can optionally be included to allow a user to deactivate actuator 18 for power consumption reasons, for example if batteries are running low. It should be noted that some embodiments of the portable computing device is configured to include a visual display of a graphical compass or other orientation pointing image. Such a visual representation of orientation may be provided in combination with the tactile sensations provided herein such that a user can selectively switch between tactile and visual orientational information access and/or use the two in combination.

It should also be noted that tin some embodiments of the portable computing device a speaker and/or other audio generating device is included. The audio generating device may be supported by additional hardware and/or software for synthetic speech generation as is known to the art. In this way the portable computing device may output synthesized and/or pre-recorded sounds that represent verbal utterances. The verbal utterances stored in memory of the present invention may include “NORTH”, “SOUTH”, “EAST” and “WEST” as well as other common orientations such as “NORTH-WEST” and “SOUTH-WEST” and “SOUTH-EAST” and “NORTH-EAST”. These utterances may be produced when the portable computing device is aligned with the corresponding direction and in combination with the tactile sensations described herein. The verbal utterances may also include generic words such as “target” for use when the portable computing device is aligned with a specially designated target direction.

As mentioned previously a variety of different tactile sensations can be imparted upon the user by the actuator (or actuators) as controlled by the microprocessor on board the portable computing device. In many embodiments the Haptic Compassing Routines select and/or define one of a plurality of possible tactile sensations based upon a particular type of geospatial orientation reference that has been encountered and/or how it has been encountered (i.e., pass-through or extended alignment). For example, different types of tactile sensations may be associated in memory and/or algorithmically with Cardinal Directions as opposed to Intermediate Incremental Directions. Similarly, different ones of the Cardinal Directions may be associated in memory and/or algorithmically with different tactile sensations. For example NORTH and SOUTH may be associated with one type of tactile sensation while EAST and WEST may be associated with a different type of tactile sensation. Similarly, different ones of the Intermediate Incremental Directions may be associated in memory and/or algorithmically with different tactile sensations. For example Intermediate Incremental Directions located at 15 degree intervals may be associated with one type of tactile sensation Intermediate Incremental Directions located at 5 degree intervals may be associated with a different type of tactile sensations. Similarly, different ways in which geospatial orientations may be encountered may be associated with different types of tactile sensations. For example, geospatial orientations that are encountered as a pass-through (i.e., the portable computing device passes through the orientation direction while in motion) may be associated with one type of tactile sensation while geospatial orientations that are encountered as an extended alignment (i.e., the portable computing device remains substantially aligned with the orientation direction for more than some threshold amount of time) may be associated with a different type of tactile sensation.

While a wide range of sensations are possible, a small number of samples are provided here as a means of example, as discussed below.

The software running upon the microprocessor of the portable computing device may be configured to control the actuator (or actuators) to impart a sensation upon the user when it is determined that a reference orientation within the portable computing device (or an aimable portion thereof) is moved such that it passes through a geospatial reference orientation in the physical world. By pass-through it is meant that the device is moved through a range of angles by the user, either in a clockwise or counter clockwise direction, such that it begins on one side of the geospatial reference orientation and moves to the other side of the geospatial reference orientation. This is determined based upon a current sensor reading collected form the orientation sensor on board the portable computing device and one or more recent previous orientation values collected from he orientation sensor on board the portable computing device. Upon determining in this way that a reference orientation within the portable computing device (or an aimable portion thereof) is moved such that it passes through a geospatial reference orientation in the physical world, the Haptic Compassing Routines select and/or define a tactile sensation from among a plurality of possible tactile sensations. Because a pass-through is generally a quick event, a short duration sensation is generally preferred. Because the pass-through may occur on a variety of different types of geospatial reference orientations (e.g., a Cardinal Direction, a Target Direction, or an Intermediate Incremental Direction), a variety of different pass-through sensations may be defined and/or selected between. Some examples of pass-through sensations that may be defined for each are: (a) Pass-Through of a Cardinal Direction: a sinusoidal vibration of frequency 80 HZ, duration 320 ms, and magnitude of 45%; (b) Pass-Through of an Intermediate Incremental Direction: a sinusoidal vibration of frequency 60 HZ, duration 180 ms, and magnitude of 30%; and (c) Pass-Through of a specific Target Direction: a saw-tooth vibration of frequency 95 HZ, duration 500 ms, and magnitude of 60%.

The pass-through sensations discussed above can optionally be impulse wave shaped such that an initial impulse accentuates the onset of each sensation for increased perceptual impact and an extended fade makes the sensation gradually dissipate rather than abruptly turn off. The details of “impulse wave shaping” are described in U.S. Pat. No. 5,959,613 by the present inventor, the disclosure of which is hereby incorporated by reference.

The software running upon the microprocessor of the portable computing device may be configured to control the actuator (or actuators) to impart a sensation upon the user when it is determined that a reference orientation within the portable computing device (or an aimable portion thereof) is positioned such that it is aligned (or substantially aligned) along a geospatial reference orientation in the physical world for more than some threshold amount of time. By substantially aligned it is generally meant that the orientation is within some range of the geospatial reference orientation. The range might be, for example, plus or minus two degrees of the reference orientation. The threshold amount of time might be, for example, 2000 milliseconds. Thus in an example embodiment if a user aims the portable computing device, or a portion thereof, within 2 degrees of a certain geospatial reference orientation and keeps it within that range for more than 2000 milliseconds, an Extended Alignment Sensation is selected and/or generated upon the user. This is determined based upon a current sensor reading collected form the orientation sensor on board the portable computing device and one or more previous orientation values collected from he orientation sensor on board the portable computing device. The previous orientation sensor values are generally associated with a time-stamp such that the time threshold requirement can be evaluated (e.g., it can be determined if the sensor readings have remained within the required range for the required amount of time). In this way the current and historical sensor values are compared against the geospatial reference orientation and range values. Upon determining in this way that a reference orientation within the portable computing device (or an aimed portion thereof) is positioned such that it is aligned (or substantially aligned) with a geospatial reference orientation for more than the threshold amount of time, the Haptic Compassing Routines select and/or define a tactile sensation from among a plurality of possible tactile sensations that are associated with an extended alignment event. Because an extended alignment is generally a multi-second event, a longer duration sensation is generally preferred. Because the extended alignment may occur on a variety of different types of geospatial reference orientations (e.g., a Cardinal Direction, a Target Direction, or an Intermediate Incremental Direction), a variety of different extended alignment sensations may be defined and/or selected between. Some example of extended alignment sensations that may be employed for each are: (a) Alignment with a Cardinal Direction: a sinusoidal vibration of frequency 80 HZ, duration 2500 ms, and magnitude of 65%; (b) Alignment with Intermediate Incremental Direction: a sinusoidal vibration of frequency 60 HZ, duration 1750 ms, and magnitude of 45%; and (c) Alignment with a specific Target Direction: a saw-tooth vibration of frequency 95 HZ, duration 3500 ms, and magnitude of 80%.

The alignment sensations discussed above can optionally be impulse wave shaped such that an initial impulse accentuates the onset of the sensation for increased perceptual impact and an extended fade makes the sensation gradually dissipate rather than abruptly turn off. The details of “impulse wave shaping” are described in U.S. Pat. No. 5,959,613 by the present inventor, the disclosure of which is hereby incorporated by reference.

In some embodiments of the present invention, the duration of the tactile sensation that is imparted upon the user is dependent upon the duration of the alignment between the portable computing device (or a select aimable portion thereof) and a geospatial reference orientation. In some embodiments the tactile sensations continues to play for as long as the alignment is maintained by the user and/or for as long as the user keeps the device in the haptic scanning mode. This is a particularly effective embodiment when a user is trying to find a single reference orientation in the physical world around him or her.

In some time-extended alignment sensation embodiments, the tactile sensation continues to play for as long as the alignment is maintained by the user and/or for as long as the user keeps the device in the haptic scanning mode, but the magnitude is reduced over time. This may be performed by implementing a gradual reduction in sensation magnitude over time until a lower threshold is reached. For example, in one embodiment the sensation begins with 75% magnitude and maintains at that magnitude for the first 1000 ms of alignment. Then over the next 4000 ms of alignment time, the sensations drops gradually in magnitude until it is reduced to a level of 35%. The sensation then continues at 35% magnitude for as long as the aligmnent is maintained by the user and/or for as long as the user keeps the device in the haptic scanning mode.

In additional embodiments of the present invention, the magnitude of the tactile sensation that is imparted upon the user is dependent upon proximity of the alignment between the portable computing device (or a select aimable portion thereof) and a geospatial reference orientation. In some embodiments the tactile sensations is imparted with a magnitude that increases as the orientation of the portable computing device approaches the orientation of the geospatial reference orientation and decreases as the orientation of the portable computing device moves away from the orientation of the geospatial reference orientation. In many cases the sensation is not played until the portable computing device orientation comes within a certain threshold angular proximity of the geospatial reference orientation and once it does, increases in magnitude as the angular proximity is reduced. This is a particularly effective embodiment when a user is trying to find a single reference orientation in the physical world around him or her because the changing magnitude allows the user to sweep the device around and hone in upon the active reference orientation.

In one example embodiment of a Variable Magnitude Alignment Sensation, the tactile sensation is not produced unless the portable computing device orientation comes within 10 degrees of the geospatial reference orientation (clockwise or counter clockwise). Once within that angular threshold, the magnitude of the sensation (which is a sine wave vibration of frequency 75 Hz) increase from 25% to 75% as an inversely linear function of angular proximity. Thus when the angular distance between the portable computing device orientation and the geospatial reference orientation is 10 degrees, the magnitude is 25%. And as the angular distance between the portable computing device orientation and the geospatial reference orientation goes to 0, the magnitude rises to 75%. The mapping can be linear. The mapping may also be non-linear.

In some embodiments of the present invention, the frequency of the tactile sensation that is imparted upon the user is dependent upon proximity of the alignment between the portable computing device (or a select aimable portion thereof) and a geospatial reference orientation. In some embodiments the tactile sensations is imparted with a frequency that increases as the orientation of the portable computing device approaches the orientation of the geospatial reference orientation and decreases as the orientation of the portable computing device orientation moves away from the geospatial reference orientation. In many cases the sensation is not played until the portable computing device orientation comes within a certain threshold angular proximity of the geospatial reference orientation and once it does, increases in magnitude as the angular proximity is reduced. This is a particularly effective embodiment when a user is trying to find a single reference orientation in the physical world around him or her because the changing frequency allows the user to sweep the device around and hone in upon the active reference orientation.

In one example embodiment of a Variable Frequency Alignment Sensation, the tactile sensation is not produced unless the portable computing device orientation comes within 10 degrees of the geospatial reference orientation (clockwise or counter clockwise). Once within that angular threshold, the magnitude of the sensation (which is a sine wave vibration of magnitude 40%) increase in frequency from 40 HZ to 100 HZ as an inversely linear function of angular proximity. Thus when the angular distance between the portable computing device orientation and the geospatial reference orientation is 10 degrees, the frequency is 40 HZ. And as the angular distance between the portable computing device orientation and the geospatial reference orientation decreases to 0, the frequency rises to 100 HZ. The mapping can be linear. The mapping may also be non-linear.

Some embodiments of the present invention may create tactile sensations that vary in BOTH magnitude and frequency as a function of alignment proximity. As also described herein, when a tactile sensation is triggered using the methods described herein, a corresponding audio signal may be accessed from memory and output to the user, the audio signal including a vocal representation corresponding with the particular geo-spatial reference orientation encountered. For example, an audio vocal representation of the word “NORTH” may be output when the geo-spatial reference orientation NORTH is encountered. In general, the onset of the audio output is output in close time-proximity to the onset of the tactile sensation such that they are logically associated in the mind of the user. Thus when the user feels the particular sensation he or she knows that sensation corresponds to a location in space that also corresponds with the vocal audio output.

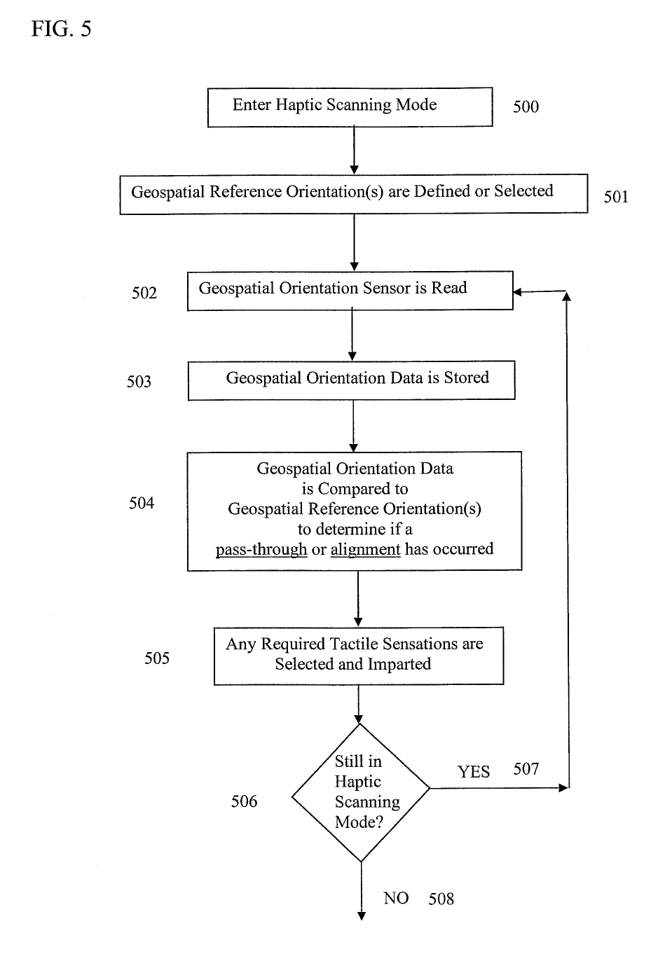

FIG. 5 illustrates a flowchart of software operations related to the Haptic Compassing Routines according to at least one embodiment of the present invention. The first step in the process starts at step 500 wherein a Haptic Scanning Mode is entered. This step may be engaged as a result of the user pressing and holding a designated button or other user interface control upon the portable computing device. This step may also be engaged by some other user interface operation performed by the user such as a voice command, a tilt-sensitive sensor that determines that the user is holding the portable computing device at or near a certain orientation (such as horizontal), or by selecting a graphical element upon the screen of the portable computing device. This step may also be engaged in response to a message received by the portable computing device from an external source, for example a message received from an external server over a communication link. The external message may be, for example, an indication that a spatially associated target is within a certain proximity of the user based upon the user's current geospatial location in the physical world. This step may also be engaged based upon the user's current location and/or orientation within the physical world and a corresponding map or other store of information related to the physical world. In general, this step may thus be engaged as a result of a user interface action, an external message, and/or a determination based in whole or in part upon the current location and/or orientation of the portable computing device within the real physical world.

Because a common embodiment of the present invention involves the user activating the Haptic Scanning Mode by pressing and holding a button or other control upon the portable computing device (or holding it at or near a horizontally level orientation), this will be the example used herein. Thus prior to step 500, the user decides to seek compassing information. He or she therefore holds the portable computing device out in front of him or her in a substantially horizontal orientation and holds a designated button down on the side of the device. In response to the button press, the software routines of the present invention cause software flow to go to step 500, beginning the haptic scanning mode.

Upon engaging this mode, the next step of the process is 501 wherein one or more geospatial reference orientations are defined and/or selected. The geospatial reference orientations are those directions with respect to the real physical world at which the haptic compassing routines will alert the user through tactile sensations. The geospatial reference orientations may be selected based in whole or in part upon the user input. For example, if the user engages a button or other control that indicates he or she desires information about the cardinal direction NORTH, this will be selected as the geospatial reference direction. Alternately if the user engages a button or other control that indicates that he or she desires information about all the Cardinal Directions, then all four will be selected as the geospatial reference directions. In some embodiments the geospatial reference orientation is selected based upon a stored map and a designated target location and/or intermediate destination and/or intermediate milestone location within that map along with current data indicating the users current location with respect to that stored map. In some embodiments the geospatial reference orientation is selected based upon spatially associated information received from a remote server over a communication link. In some embodiments the geospatial reference direction is selected based upon a current mode of operation as selected by the user. Regardless of how the one or more geospatial reference orientations are selected, they are stored in memory upon the portable computing device. For embodiments wherein the geospatial reference orientation is dependent upon the current GPS location of the user, the reference orientation may be repeatedly updated over time as the user's GPS location changes.

With the geospatial reference orientations defined, the next step is to cause the software flow to proceed to step 502 wherein the geospatial orientation sensors on board the portable computing device (or an aimable portion thereof) is read by the processor on board the portable computing device. The orientation sensors may be, for example, one or more magnetometer sensors that are tilt-compensated using accelerometer sensors such that data is provided as to the geospatial orientation that the portable computing device (or a portion thereof) is aiming. The geospatial orientation data may be reported in many forms. One common form of the data is as an angle value from 0.0 degrees to 360.0 degrees such that the angular value represents the clockwise angle away from NORTH. This data may be reported with respect to magnetic NORTH or geographic NORTH depending upon the configuration of the system. In one example embodiment, the value is reported as an angle A that indicates the clockwise rotary orientation in degrees away from geographic NORTH that the portable computing device (or an aimable portion thereof) is being aimed at the moment the data was read by the processor. This angle A is stored in local memory on board the portable computing device in step 503. In many embodiments of step 503 the data (i.e., angle A) is also stored along with a time-stamp value that indicates the precise time of day that the angle was captured by sensors. This angle A along with the optional time-stamp value is generally stored in an area of memory wherein a plurality of such recent values are stored. For example, in one such embodiment the 100 most recent geospatial orientation values are stored in memory along with their respective time-stamp value. In this way the portable computing device may store a recent time-history of geospatial orientation values. This time history need not include 100 values. For example, in some embodiments only a small number of recent values are stored in memory. In general, the oldest values are overwritten in memory as new values are captured from the sensor and stored. The time-history is useful in determining pass-through events and/or alignment events as will be described later.

With the current geospatial orientation of the portable computing device (or a portion thereof) being derived based on data from one or more sensors in 502 as and then stored in memory (optionally along with a time-history of other recent values) in step 503, the process proceeds to step 504. In this step the current geospatial orientation data samples (and optionally one or more recent historical geospatial orientation data samples) is compared with the geospatial reference orientation(s) that are currently active to determine if a tactile sensation is to be produced. In general a tactile sensation is produced if the data comparison indicates that either (a) the orientation of the portable computing device (or a particular aimable portion thereof) has just passed-through an active geospatial reference orientation or (b) the orientation of the portable computing device (or a particular aimable portion thereof) has just become substantially aligned with an active spatial reference orientation for more than some threshold amount of time. These determination of these two conditions are described in more detail below.

In many embodiments step 504 involves the selection of a particular tactile sensation from a plurality of possible tactile sensations by the software routines of the present invention. The particular tactile sensation selected and/or defined is often dependent upon (i) whether a pass-through or extended alignment has occurred and/or (ii) what type of geospatial reference orientation was passed-through or aligned with. Thus a variety of different tactile sensations may be selected among as described previously.

With respect to the determination of whether or not a pass-through of an active geospatial reference orientation has occurred as a result of the user moving the portable computing device, step 504 is performed in some embodiments through a computational analysis in which the most current orientation value for the portable computing device and the next most current orientation value for the portable computing device are both considered. The next most current orientation value for the portable computing device may be, for example, 100 milliseconds in the past (i.e., it reflects the orientation that the portable computing device was at 100 milliseconds previous). These two values define a range that indicates the angles through which the portable computing device moved during the past 100 milliseconds. The computational analysis then determines if an active geospatial reference orientation falls within that range. If so, a pass-through has occurred.

This process may be clarified by example. In one embodiment a target geospatial reference orientation is defined at an angle that is 66.0 degrees clockwise away from geographic NORTH in physical world. The most current sensor reading for the portable computing device indicates that it is substantially currently aimed at a direction of 69.0 degrees clockwise away from geographic NORTH. The next most recent orientation value that is stored in memory is for a time-stamp that is 100 milliseconds in the past and indicates that at that time the portable computing device was aimed at a direction that was 64.5 degrees clockwise away from geographic NORTH. Thus the device moved from 64.5 degrees to 69.0 degrees clockwise away from geographic NORTH over the past 100 milliseconds. The analysis is then performed, determining through simple mathematical operations that the reference orientation (i.e., 66.0 degrees) falls within the range between 64.5 degrees and 69.0 degrees. Thus it is determined by simple math that a pass-through did occur during the past 100 milliseconds. A sensation may then be produced by the routines of the present invention in response to this determination. Because there was 100 ms between subsequent data samples on board the portable computing device, the delay between the pass-through and the sensation generation will be at least 150 ms. To achieve a smaller time delay and thereby get better time-proximity between the pass through event and the associated sensation, it is desirable to collect repeated data samples of the sensor on board the portable computing device at a rapid rate. In many embodiments of the present invention this rate may be smaller than the 100 ms interval used in the example above. Based upon perceptual limits of humans, a sampling interval of less than 30 ms is desirable. In this way the time delay is likely not to be noticeable to the human user. In some embodiments sampling intervals less than 10 ms may be used.

In some embodiments, not only is a pass-through determined but also the direction in which the portable computing device was moving when the pass-through occurred is also determined. This direction may also be used to influence the type and/or form of the tactile sensation.

With respect to the determination as to whether of not an extended alignment with an active geospatial reference orientation has occurred, step 504 is preformed in some embodiments through a computational analysis in which a time history of orientation value for the portable computing device are considered with respect to one or more geospatial reference orientations. More specifically, a particular time-threshold and angular-threshold is defined for the determination of an extended alignment. The angular threshold is the range of angles around a geospatial reference orientation that is near enough that the portable computing device is considered substantially aligned. This angular range threshold may be, for example, plus or minus 2 degrees. This value may be hard-coded into the software of the present invention, may be a configurable parameter that the user can adjust through setup windows, or is a parameter that varies depending upon the type of geospatial reference orientation. The time-threshold is the amount of time that the orientation of the portable computing device must remain within the angular threshold range of a geospatial reference orientation for it to be considered an extended alignment. The time-threshold may be, for example, 2000 milliseconds. This value may be hard-coded into the software of embodiments of the present invention, and may be a configurable parameter that the user can adjust through setup windows, or may be a parameter that varies depending upon the type of geospatial reference orientation.

Thus with a time-threshold and angular-threshold defined and/or accessed by the software, step 504 is operative to determine if the portable computing device, as positioned by the user during a haptic scanning mode, is currently aligned with a reference orientation (within the angular threshold limits) and has been aligned for more than the time-threshold amount of time. This can be preformed in many ways. In some embodiments, the most current orientation of the portable computing device is compared with the angular threshold range around a geospatial reference orientation to determine if the portable computing device currently falls within the range. If so, a number of recent historical values (as stored in memory) for the portable computing device orientation are then compared with the angular threshold range around the geospatial reference orientation. These are generally compared in sequence, starting with the most recent historical orientation values in memory and progressing backward through memory to the oldest historical values for the portable computing device, until a historical value is processed that corresponds with a time-stamp that is equal to or more than the time-threshold back in time. If all of the historical values, from the most recent, to the ones that are equal to or just older than the time-threshold fall within the angular threshold limits, then it is determined that the portable computing device has remained substantially aligned with the geospatial reference target for the time-threshold amount of time. A corresponding tactile sensation is then selected and imparted by the routines of embodiments of the present invention.

There are other ways in which an extended alignment may be determined. In one alternate embodiment, every time it is determined that the portable computing device orientation comes within the angular threshold range of a geospatial reference orientation, a timer begins counting and continues counting as a background software process until it is determined that the portable computing device orientation no longer falls within the angular threshold range of the geospatial reference orientation. If the counter reaches a value that equals or exceeds the time-threshold value, then an extended alignment is determined to have occurred. A corresponding tactile sensation is then selected and imparted by the routines of the present invention.

Once step 504 is performed, the routines of embodiments of the present invention will have determined if any pass-through events and/or extended alignment events have occurred. The software process then proceeds to step 505 wherein any required tactile sensations are selected and imparted. These sensations may be dependent upon (i) whether a pass-through event or extended alignment event has occurred and/or (ii) what type of geospatial reference orientation was passed-through or aligned with. Thus a variety of different tactile sensations may be selected among as described previously. In some embodiments the tactile sensations is produced over an extended period of time that depends upon the orientation data for the portable computing device as collected in subsequent cycles of the program flow.

Once step 505 is performed, the software proceeds through a repetitive loop in which many of the steps describe above are repeated, starting from step 502 in which current orientation data is collected for the portable computing device. This loop continues based upon a conditional determination made at 506. At 506 it is determined whether or not the haptic scanning mode is still active. If yes 507, the process branches back to 502 and the loop repeats. If the haptic scanning mode is no longer active, the process ends at 508, returning to another process until the next time a haptic scanning mode is entered. In this way the process may loop, for example, during the time that user holds down a haptic scanning mode button, and then ends when the user lets go of that button. Again, other methods may be used to engage and/or disengage the haptic scanning mode. When engaged, the user will feel tactile sensations if and when the portable computing device passes-through and/or has an extended alignment with one or more geospatial reference orientations. In this way the user, when moving the portable computing device around while in the haptic scanning mode, will get tactile cues that help the user orient himself or herself in the real physical world with respect to one or more geospatial reference orientations. This will help to improve the situational awareness of a user who trying to navigate the real world, looking to find spatially associated information within the real physical world, following computer driven paths or instructions that guide him or her through the real physical world, or otherwise needs enhanced orientational awareness of himself or herself with respect to the real physical world.

The various embodiments discussed above often describe the portable computing device of the present invention as a handheld device such as a PDA, cell phone, or portable media player. While such embodiments are highly effective implementations, a range of other physical embodiments may also be constructed that employ the present invention. For example, a wrist worn embodiment of the present invention may be employed.

Other embodiments, combinations and modifications of this invention will occur readily to those of ordinary skill in the art in view of these teachings. Therefore, this invention is not to be limited to the specific embodiments described or the specific figures provided.

This invention has been described in detail with reference to various embodiments. Not all features are required of all embodiments. It should also be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art. Numerous modifications and variations could be made thereto by those skilled in the art without departing from the scope of the invention set forth in the claims.

What is claimed is:

1. A portable navigation device, comprising:
a handheld casing to be pointed in a direction by a user;
a computer processor disposed within the handheld casing;
a user input element in communication with the processor to receive a user input;
an orientation determination component disposed within the handheld casing to determine a current geospatial pointing orientation of the casing of the portable navigation device; and
a haptic actuator affixed to the handheld casing of the portable navigation device to provide tactile feedback to the user in response to user manipulation of the handheld casing and user interaction with the user input element, wherein a tactile feedback sensation is imparted when the current geospatial pointing orientation of the handheld casing is made to substantially correspond with at least one target geospatial pointing orientation within the physical world.

2. The portable navigation device of claim 1 wherein the orientation determination component comprises a magnetometer.

3. The portable navigation device of claim 1 wherein the orientation determination component comprises a GPS transducer.

4. The portable navigation device of claim 1 wherein the at least one target geospatial pointing orientation includes a North pointing orientation.

5. The portable navigation device of claim 1 wherein the at least one target geospatial pointing orientation comprises four Cardinal Direction pointing orientations.

6. The portable navigation device of claim 1 wherein the at least one target geospatial pointing orientation comprises a current travel direction required of the user as determined by a stored navigation route or map and a current geospatial location of the user.

7. The portable navigation device of claim 1 further comprising at least one of a display to provide visual feedback and an audio device to provide audio feedback.

8. The portable navigation device of claim 1 wherein the tactile feedback comprises a vibration sensation.

9. The portable navigation device of claim 8 wherein at least one of a magnitude and a frequency of the vibration sensation is imparted differently for each of a plurality of different target geospatial pointing orientations.

10. The portable navigation device of claim 9 wherein the vibration sensation imparted to correspond to a North geospatial pointing orientation is greater in magnitude than vibrations imparted to correspond to a plurality of other target geospatial pointing orientations.

11. The portable navigation device of claim 1 wherein the user input element comprises a depressible button.

12. The portable navigation device of claim 11 wherein a tactile sensation is imparted only in response to the user depressing the depressible button while orienting the casing in the direction of a target geospatial pointing orientation.

13. The portable navigation device of claim 1 wherein the current geospatial pointing orientation of the handheld casing is determined to substantially corresponds with a target geospatial pointing orientation in the physical world in response to the current geospatial pointing orientation of the handheld casing coming within a predetermined angular range of the target geospatial pointing orientation.

14. The portable navigation device of claim 1 wherein a tactile sensation is imparted on the user only in response to the casing of the portable navigation device being pointed substantially in the direction of the target geospatial pointing orientation for at least a threshold amount of time.

15. The portable navigation device of claim 1 wherein the at least one target geospatial pointing orientation comprises an object locative orientation that indicates the direction that the user should look to find a particular physical object within the physical world.

16. The portable navigation device of claim 15 wherein the object locative orientation is received by the portable navigation device from a remote server over a communication link.

17. A method of providing a tactile portable navigation device comprising:
providing a handheld casing to be pointed in a direction by a user;
providing a computer processor disposed within the handheld casing;
providing a user input element in communication with the processor to receive a user input;
providing a haptic actuator connected to the processor to impart tactile feedback to the user under selective processor control;
repeatedly determining a current geospatial pointing orientation of the casing of the portable navigation device using an orientation determination component disposed within the handheld casing; and
imparting tactile feedback to the user of the portable navigation device in response to changes in the geospatial pointing orientation of the handheld casing, wherein a tactile feedback sensation is imparted in response to a pointing orientation of the handheld casing being made to substantially correspond to at least one target geospatial pointing orientation within the physical world.

18. The method of claim 17 wherein the at least one target geospatial pointing orientation comprises a North pointing orientation.

19. The method of claim 17 wherein the at least one target geospatial pointing orientation includes a travel direction required of the user as determined by a stored navigation route or map.

20. The method of claim 17 wherein the pointing orientation of the handheld casing is determined to substantially corresponds with a target geospatial pointing orientation in response to the pointing orientation of the handheld casing coming within a predetermined angular range of a target geospatial pointing orientation within the real physical world.

21. The method of claim 20 wherein the angular range is plus or minus 2 degrees.

22. A portable navigation device, comprising
a handheld casing to be pointed in a direction by a user;
a processor disposed within the handheld casing;
a memory coupled to the processor containing values representing at least one target geospatial pointing orientation within the real physical world;
an orientation determination component disposed within the handheld casing to determine a current geospatial pointing orientation of the casing of the portable navigation device; and
a haptic actuator affixed to the handheld casing of the portable navigation device to provide tactile feedback to the user in response to user manipulation of the handheld casing, wherein a tactile feedback sensation is imparted under processor control in response to the pointing orientation of the handheld casing being made to substantially correspond to a target geospatial pointing orientation stored in the memory.

23. The portable navigation device of claim 22 wherein the tactile feedback is only provided when a user interface element is being engaged by the user upon the portable navigation device.

24. The portable navigation device of claim 23 wherein the user interface element comprises a button that is engaged by being held in a deposed position by the user.

25. The portable navigation device of claim 22 wherein at least one of a magnitude and a frequency of the tactile sensation is varied over time in response to how well the pointing orientation of the handheld casing corresponds with a target geospatial pointing orientation.
